(19) United States
(12) Patent Application Publication
(10) Pub. No.: US 2004/0131898 A1
(43) Pub. Date: Jul. 8, 2004

(54) Reactant feed apparatus for direct feed fuel cells and methods related thereto

(75) Inventors: Jiujun Zhang, Richmond (CA); Kevin M. Colbow, West Vancouver (CA); Alvin N. L. Lee, Vancouver (CA); Bruce Lin, Vancouver (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Inc., Burnaby (CA)

(21) Appl. No.: 10/337,921

(22) Filed: Jan. 6, 2003

(51) Int. Cl. H01M 8/00

(52) U.S. Cl. 429/12

(57) ABSTRACT

Disclosed are reactant feed apparatus for liquid-fueled direct feed fuel cells, including miniaturized versions thereof. More specifically, disclosed is a fuel flow device for delivering liquid fuel to such direct feed fuel cells. The fuel flow device comprises a fuel flow-routing device and an enclosure/partition assembly containing the liquid fuel to be delivered. When the fuel flow device is fluidly connected to the fuel cell, it operates to deliver the liquid fuel to an anode flow field thereof by using the pressurized anodic exhaust gases exiting therefrom as the source of power for pumping the liquid fuel from the enclosure into the fuel cell.

Also disclosed is a cathode flow field plate that utilizes an array of island members to provide multi-directional oxidant flow channels and expedite the passive delivery of oxidant to, and removal of product water from, a cathode flow field of a liquid-fueled direct feed fuel cell. Further, disclosed are methods for delivering liquid fuel and oxidant to the fuel cells using the above-disclosed devices.

### BACKGROUND OF THE INVENTION

1. Field of the Invention

The present invention generally relates to the delivery of reactants to the electrodes of electrochemical fuel cells, and more particularly to an exhaust gas-driven fuel flow device for delivering a liquid fuel to the anode of a direct feed electrochemical fuel cell, and to a flow field plate design allowing for greater rates of oxidant delivery to, and product water removal from, the cathode of such a fuel cell.

2. Description of the Related Art

Electrochemical fuel cells (“fuel cells”) have been the focus of considerable attention, as they can generate electricity in a clean and efficient manner. The reactants used for fuel cells include a fuel and an oxidant. The fuel is typically gaseous hydrogen or a hydrocarbon/water mixture (e.g., methanol and water) that may be gaseous or a liquid. The oxidant is typically gaseous oxygen, either in a purified form or in air.

There are a number of types of fuel cells, often distinguished by the type of electrolyte used therefor. When classified according to the type of electrolyte used, most fuel cells are then identified as alkaline, acid, molten carbonate, solid oxide, or polymer electrolyte membrane (“PEM”) fuel cells.

Fuel may be supplied to a fuel cell either directly or indirectly. In the latter case, the supplied fuel is chemically converted externally into a suitable electrochemical reactant before entering the fuel cell. (For example, hydrogen reactant may be derived from a fuel supply consisting of organic compounds which are catalytically reformed and processed outside of the fuel cell.) In a direct feed fuel cell (hereinafter, “DFFC”), the fuel supplied directly to the fuel cell may be converted internally into a suitable electrochemical reactant (i.e., internal reforming as in certain high temperature fuel cell types) or may be directly oxidized at the anode. A direct methanol fuel cell (“DMFC”) is a type of liquid-fueled direct feed, PEM fuel cell that uses a methanol/water mixture as the supplied fuel. The mixture is fed directly to the anode and is directly oxidized there. Such a liquid fuel supply is particularly suitable for miniature fuel cells.

In a PEM fuel cell, fuel reactant is reacted at the anode to generate cations, typically protons, that pass through the electrolyte to the cathode, and electrons that cannot pass through the electrolyte and, thus, are forced to pass through an external circuit (providing electrical power) to the cathode. At the cathode, protons, electrons and oxygen combine to yield water and heat.

A PEM fuel cell includes a membrane electrode assembly (“MEA”). The MEA is an assembly of an anode and a cathode, with a PEM sandwiched therebetween. These MEA components are typically assembled in a planar configuration; however, other configurations are possible. For example, the components can be cylindrical and assembled as an arrangement of concentric cylinders. To provide a sufficient power output, MEAs are typically stacked in a fuel cell stack. Interposed between adjacent MEAs in a fuel cell stack are separator plates, also referred to as current collectors. The plates provide structural support and a conductive pathway for electrons flowing from anodes and toward cathodes. Separator plates typically incorporate flow fields made of passageways, such as channels, in fluid communication with the electrodes adjacent thereto, through which fuel and oxidant can flow so as to contact the appropriate electrodes. Such separator plates are referred to as flow field plates.

Fuel and oxidant must be delivered to the anodes and cathodes in a fuel cell stack at a rate sufficient to yield an acceptable power density. One approach is to pump liquid fuels, and compress or blow gaseous fuels and oxidants into the fuel cell stack. However, there are two basic drawbacks, aside from adding complexity and cost to fuel cell power systems, of adding such devices. The first is associated with the added space taken up by the devices. For a number of applications, it is desirable to minimize the space taken up by the fuel cell power plant. The second drawback is associated with the power consumed by such devices. To the extent that the devices are thus parasitic, the power density of the power plant is diminished. Thus, to meet a given power requirement, the power plant must be larger and/or more fuel must be consumed.

Such drawbacks are particularly problematic in the case of miniature fuel cell applications (e.g., powering portable electronic devices) where minimizing power plant volume and maximizing power density and fuel efficiency is especially important. At the same time, effective fuel and oxidant replenishment and product removal (i.e., replenishment and removal carried out at rates sufficient to allow for required or desired power densities) are particularly troublesome technical barriers in the practical operation of a miniature fuel cell power plant.

In the case of larger fuel cell power plants, electrically powered pumps, compressors and blowers are often used to feed fuel to the anodes and oxidant to the cathodes thereof. Typically, the electrical power is provided by the fuel cell stack. For example, U.S. Pat. No. 6,254,748 describes a DFFC power plant that includes a compressor to feed oxygen or air to the cathode chambers thereof and force therefrom the oxidation reaction products, and a pump to inject an organic compound/water fuel mixture into the anode chambers thereof and force fuel reaction products from the stack. The compressor and pump diminish the power density of the overall system through the associated parasitic power loss and space taken up.

In the case of miniature fuel cells, the conventional method for feeding liquid fuel to the fuel cell stack uses gravitational flow, capillary flow, natural diffusion, and/or natural convection of the fuel to anode surfaces from a fuel reservoir. Also, fuel reaction products are transported away from the anode surfaces to the atmosphere by means of diffusion and/or natural convection. For example, the Jet Propulsion Laboratory has demonstrated a DMFC with fuel being fed by diffusion to yield a power density of 8 mW/cm² (see Mench et al., “Design of a Micro Direct Methanol Fuel Cell (μDMFC),” Proceedings of the IMECE '01 New York, Nov. 11-16, 2001). Also, a DMFC, having a total volume of 1 cm³ and expected to have a power density of about 1 W/cm³, has been proposed that uses gravitational and capillary forces to feed fuel to its anodes (see Mench et al.). However, such methods are of limited effectiveness, particularly with regard to feeding fuel to a fuel cell stack either in a controlled fashion, or at a rate sufficient to yield a required minimum power output.

In addition, micro-pumps and sensors are being developed to actively control fuel flow and concentrations to and within fuel cell stacks. In this regard, Motorola has demonstrated a micro-DMFC that uses external pumping to achieve a power density of 15 mW/cm² (see Mench et al.) However, such devices are at an early stage of development and cost parasitic power.

Delivering oxidant to, and removing product water from, the cathodes of an electrochemical fuel cell stack is particularly problematic where the stack is miniaturized. Ideally, it is desirable to effect a forced flow of oxidant (e.g., air) to the cathode to both insure a rate of oxidant delivery thereto that can provide a desired power density, and to create a pressure drop allowing for effective water management (e.g., prevent flooding of cathode by liquid water). However, aside from the issue of the parasitic power loss associated with devices capable of producing such forced flow, use of the devices is highly disadvantageous from the standpoint of system volume and, correspondingly, system power density. This is because the ability to miniaturize such devices is limited.

Thus, it is desirable, in the case of miniature fuel cells, to deliver oxidant to, and remove product water from, the cathodes thereof by diffusion and/or natural convection. However, the rate of such delivery and removal is limited. One solution has been to connect miniature fuel cells in series in a planar arrangement to yield a fuel cell stack having cathode surfaces that are fully exposed to the atmosphere (i.e., little or no structure to block diffusion or inhibit convection). Such planar designs have been proposed, for example, by the Jet Propulsion Laboratory (see, e.g., S. R. Narayanan et al., The 199^{th} ECS Washington Meeting Abstracts, #95, JPL, 2001); Motorola (see, e.g., U.S. Pat. No. 6,127,058); and Manhattan Scientifics (see, e.g., R. G. Hockaday et al., 2000 Fuel Cell Seminar Abstracts, Portland, 791-794, 2000).

However, a planar arrangement suffers from less than ideal geometry for a number of miniaturized applications and from yielding a high internal stack resistance associated with the thin electrical connections between the fuel cells arranged in the planar layer. Stacking miniature fuel cells, instead of arranging them in a plane, is advantageous in providing a more compact geometry, as well as improved electrical contact (e.g., less resistance) between adjacent cells. However, access to the fuel cell cathodes by an oxidant and from the cathodes to an external environment by the product water, is more limited.

Current methods typically provide for such access using cathode flow field plates having generally parallel, continuous channels integrally formed therein (see, e.g., M. M. Mench et al., “Design of a Micro Direct Methanol Fuel Cell,” Proceedings of the IMECE '01, New York, Nov. 11-16, 2001). The function of such a flow field plate has been described as attributed to the oxidant (e.g., ambient air) becoming warmer and more moist as it travels through a channel thereof, thereby promoting a density driven flow of ambient air through the channel. Nevertheless, the rate of oxidant delivery to, and product removal from, miniature fuel cell cathodes, and, thus, the power density achievable from associated fuel cell stacks is limited.

Cathode flow field plates comprising arrays of island members have been described in the art for direct feed fuel cells employing gaseous fuel (e.g., Japanese Patent Application Publication No. 11-126623 (May 11, 1999) Japanese Patent Application Publication No. 07-230815 (Aug. 29,1995) and European Patent Application Publication No. EP 0924 785 A2 (Jun. 23,1999)). However such designs are less preferred for purposes of water removal since they are characterized by smaller pressure drops and are more prone to having “dead” zones. The typical liquid-fueled DFFC, e.g., DMFC, generally has more water to deal with at the cathode than in gaseous fuel counterparts. Thus, such flow field plates do not seem suitable in a DMFC. Instead, it is suggested in the prior art that a substantially continuous and mono-directional flow channel is needed to promote a sufficient density-driven flow of gaseous oxidant therethrough to thereby provide acceptable passive delivery of oxidant and removal of product water from miniature fuel cells.

Accordingly, there remains a need in the art for devices and methods for delivering fuel and oxidant to direct feed fuel cells and fuel cell stacks, including miniaturized versions thereof, and for removing reaction products therefrom, at greater rates. Such devices and methods should preferably add little or no system volume or cost little or no parasitic power loss, and thereby achieve greater system power densities. The present invention fulfills these needs and provides further related advantages.

### BRIEF SUMMARY OF THE INVENTION

The present invention is generally directed to an exhaust gas-driven fuel flow device for delivering a liquid fuel to the anode flow field of a DFFC or stack thereof, and is also generally directed to a cathode oxidant flow field plate for expediting the delivery of oxidant by diffusion and/or natural convection to the cathode of a DFFC or stack thereof. The fuel flow device delivers the liquid fuel while consuming only minimal electrical power and while otherwise being a source of only minimal parasitic power loss. In addition, the fuel flow device is suitable for a DFFC that reacts a liquid fuel (e.g., organic fuel/water mixture) therein to generate a gaseous product stream comprising anodic reaction products and unreacted fuel (“exhaust gas”). The fuel flow device is driven by the exhaust gas generated within, and exiting from, the anode flow field of the DFFC.

Accordingly, in one embodiment, a fuel flow device is disclosed that comprises a fuel flow-routing device and an enclosure/partition assembly. The enclosure has an inlet and an outlet, the outlet being for fluid connection, during operation, to an inlet of an anode flow field of a liquid-fueled DFFC. The partition is located within the enclosure so as to slideably engage its inner walls. The fuel flow-routing device includes an inlet port for fluid connection to an outlet of the anode flow field, a first outlet port for fluid connection to an environment at a pressure less than that in the anode flow field during operation, and a second outlet port fluidly connected to the enclosure inlet.

The partition divides the interior space of the enclosure into first and second chambers and provides a substantially fluid-impenetrable barrier therebetween. The first chamber is fluidly connected to the enclosure inlet and is adapted to contain the exhaust gas, and the second chamber is fluidly connected to the enclosure outlet and is adapted to contain the liquid fuel to be delivered. The partition, in a related embodiment, is a piston adapted to move, during operation, only so as to cause the second chamber volume to decrease and the first chamber volume to increase.

The fluid flow-routing device is adapted to provide, in an alternating fashion: 1) a first fluid connection between the inlet port and second outlet port while fluidly isolating the same from the first outlet port; and 2) a second fluid connection between the inlet port and first outlet port while fluidly isolating the same from the second outlet port. The fluid flow-routing device, in a related, more specific embodiment, is a 3-way valve.

In another representative embodiment, the present invention is also directed to a method for delivering a liquid fuel to the anode of a DFFC. The method comprises the steps of: a) providing the DFFC having an anode flow field, and a disclosed exhaust gas-driven fuel flow device, the anode flow field and fuel flow device being as described above and fluidly connected, also as described above, and the fuel flow device having a quantity of the liquid fuel to be delivered contained in the second chamber of the enclosure thereof; and b) operating the fluid flow-routing device to alternatingly provide 1) a first fluid connection between the inlet port and the second outlet port, while fluidly isolating the same from the first outlet port, to thereby establish equal pressures within the first and second chambers; and 2) a second fluid connection between the inlet port and first outlet port, while fluidly isolating the same from the second outlet port to thereby cause the pressure within the first chamber to exceed that within the second chamber, in turn, causing the partition to move and push a quantity of liquid fuel from the second chamber to the anode flow field.

Disclosed in another aspect of the present invention is a liquid-fueled DFFC stack comprising a plurality of stacked liquid-fueled DFFCs, each having a cathode flow field plate, at least one of which consists essentially of an electrically conductive planar base plate having first and second major surfaces and a plurality of electrically conductive, rigid island members projecting from the first major surface. Each island member has a projecting end. The projecting ends of the island members collectively provide a landing for contact with a cathode. In a related embodiment, disclosed is a liquid-fueled DFFC stack comprising at least one bipolar plate, where the bipolar plate comprises a disclosed cathode flow field plate.

In yet another embodiment, the present invention is directed to a method for enhancing the performance of a liquid-fueled DFFC stack, having gaseous oxidant passively delivered thereto and product water passively removed therefrom. The disclosed method comprises employing at least one disclosed cathode flow field plate. As noted, the latter consists essentially of an electrically conductive planar base plate having first and second major surfaces, and a plurality of electrically conductive, rigid island members projecting from the first major surface and having projecting ends, the projecting ends collectively providing a landing for contact with a cathode.

These and other aspects of the present invention will be evident upon reference to the following detailed description and attached drawings. To this end, a number of articles and patent documents are cited herein to aid in understanding certain aspects of this invention. Such documents are hereby incorporated herein by reference in their entirety.

### BRIEF DESCRIPTION OF THE SEVERAL VIEWS OF THE DRAWINGS

FIG. 1 is a schematic illustration of a fuel flow device according to an embodiment of the present invention, shown fluidly connected to a fuel cell, the exhaust gases from the anode flow field thereof shown fluidly connected through the fluid flow routing valve (having a rotating valve body with a two-legged passageway) to the cylinder/piston assembly of the fuel flow device.

FIG. 2 is a schematic illustration of a fuel flow device according to an embodiment of the present invention, shown fluidly connected to a fuel cell, the exhaust gases from the anode flow field thereof shown vented through the fluid flow-routing valve (having a rotating valve body with a two-legged passageway) of the fuel flow device, through an optional exhaust tank, and then to an ambient environment.

FIG. 3 illustrates top views and a cross-sectional elevation view of the cathode and anode side of a miniature bipolar plate according to an embodiment of the present invention.

FIG. 4 comparatively illustrates cell output voltage and power density as functions of cell output current density for a miniature fuel cell where the cathode thereof has oxidant delivered thereto by diffusion and/or natural convection 1) while fully exposed to the atmosphere, 2) through the 0.2 cm deep mono-direction channels of a conventional flow field plate, and 3) through the 0.2 cm deep passageways of a flow field plate according to an embodiment of the present invention.

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE INVENTION

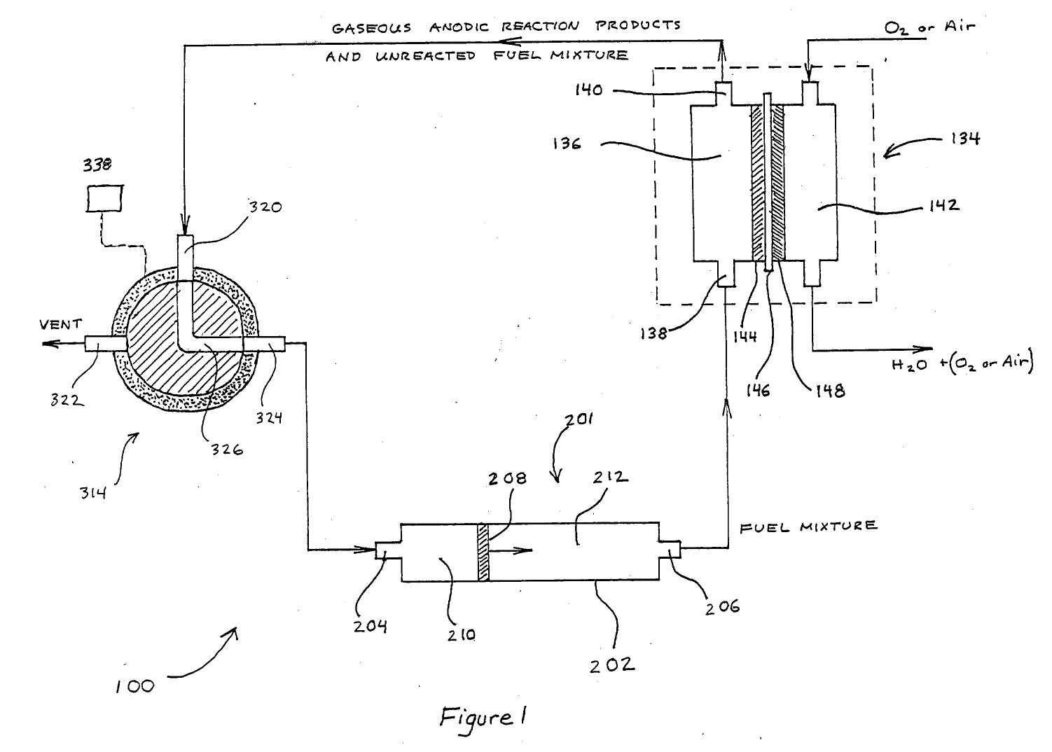

As noted above, the present invention is generally directed, in one aspect, to devices and methods for delivering a liquid fuel to the anode of a DFFC without being a source of significant parasitic, electrical power loss. In another aspect, the present invention is directed to cathode flow field plates for direct feed electrochemical fuel cell stacks, where the disclosed flow field plate design expedites the delivery of oxidant to the stacks by diffusion and/or natural convection. Specific details of certain embodiments of the invention are set forth in the following description and illustrated in FIGS. 1-4 to provide a thorough understanding of such embodiments. One skilled in the art, however, will understand that the present invention may have additional embodiments, or may be practiced without several of the details described in the following description and illustrated in the figures.

In one representative embodiment, disclosed is an exhaust gas-driven fuel flow device adapted to deliver a liquid fuel to the anode flow field of a DFFC, where the flow device comprises an enclosure having an inlet and an outlet, the outlet being fluidly connected to an inlet of the anode flow field; a partition located within the enclosure; and a fluid flow-routing device comprising an inlet port, a first outlet port, and a second outlet port. The inlet port is fluidly connected to an outlet of the anode flow field, the first outlet port is fluidly connected to an environment at a pressure less than that in the anode flow field during operation, and the second outlet port is fluidly connected to the enclosure inlet. In a related embodiment, the environment is ambient at substantially atmospheric pressure.

The partition divides the interior space of the enclosure into first and second chambers, the first chamber being fluidly connected to the enclosure inlet and adapted to contain an exhaust gas from the anode flow field, and the second chamber being fluidly connected to the enclosure outlet and adapted to contain the liquid fuel.

The fluid flow-routing device is adapted to provide, in an alternating fashion: 1) a first fluid connection between the inlet port and the second outlet port while fluidly isolating the same from the first outlet port; and 2) a second fluid connection between the inlet port and the first outlet port, while fluidly isolating the same from the second outlet port.

As used herein, the term “deliver” is synonymous with the terms “flow,” “feed” and “pump.” Also, as used herein, the expression “anode flow field” refers to the collective volume of the anode passageways (through which the liquid fuel flows) that are adjacent to and in fluid communication with the anode of a DFFC. The expression “exhaust gas,” as used herein, refers generally to a gaseous mixture of anodic reaction products (reaction products from the oxidation of fuel at the anode) and unreacted fuel exiting the anode flow field of a DFFC.

Also, as used herein, a liquid-fueled DFFC refers to a fuel cell that oxidizes at least one organic compound, comprised in a liquid fuel, at an anode thereof to generate electrons, cations (e.g., protons) and an exhaust gas comprising CO₂, where the cations can migrate through the electrolyte to the cathode of the fuel cell, whereas the electrons cannot. Accordingly, the phrases “liquid fuel” and “liquid fuel mixture,” as used herein, refer to such an organic compound, or a mixture of such compounds, that may be combined with an additional compound (e.g., water) needed for the above oxidation.

In certain embodiments of a fuel flow device disclosed herein, the organic compound, so oxidized, is combined with water in a liquid fuel mixture. In further related embodiments, the organic compound is an alcohol, a methoxymethane, formic acid, methyl formate or hydrazine. In yet further related embodiments, the methoxymethane is dimethoxymethane or trimethoxymethane, and the alcohol is methanol. As noted previously, a liquid-fueled DFFC that directly utilizes a liquid fuel mixture that comprises methanol and water is commonly referred to as a direct methanol fuel cell (DMFC).

The term “enclosure,” as used herein, refers to any enclosure adapted to contain a fluid. The term “partition,” as used herein, generally refers to any movable structure located within the enclosure, and configured and engaged with interior surfaces thereof so as to divide the interior of the enclosure into first and second chambers of variable-volume, while providing a substantially fluid-impenetrable barrier therebetween. Examples of such a partition include, but are not limited to, a piston, slideably engaged with a cylindrical enclosure, and a balloon-like membrane, fixed at its periphery to an enclosure that may or may not be cylindrical. Further, the phrase “fluid flow-routing device,” as used herein, refers to any device such as, for example, a 3-way valve, capable of providing a fluid connection between a location and one, at a time, of two or more other locations.

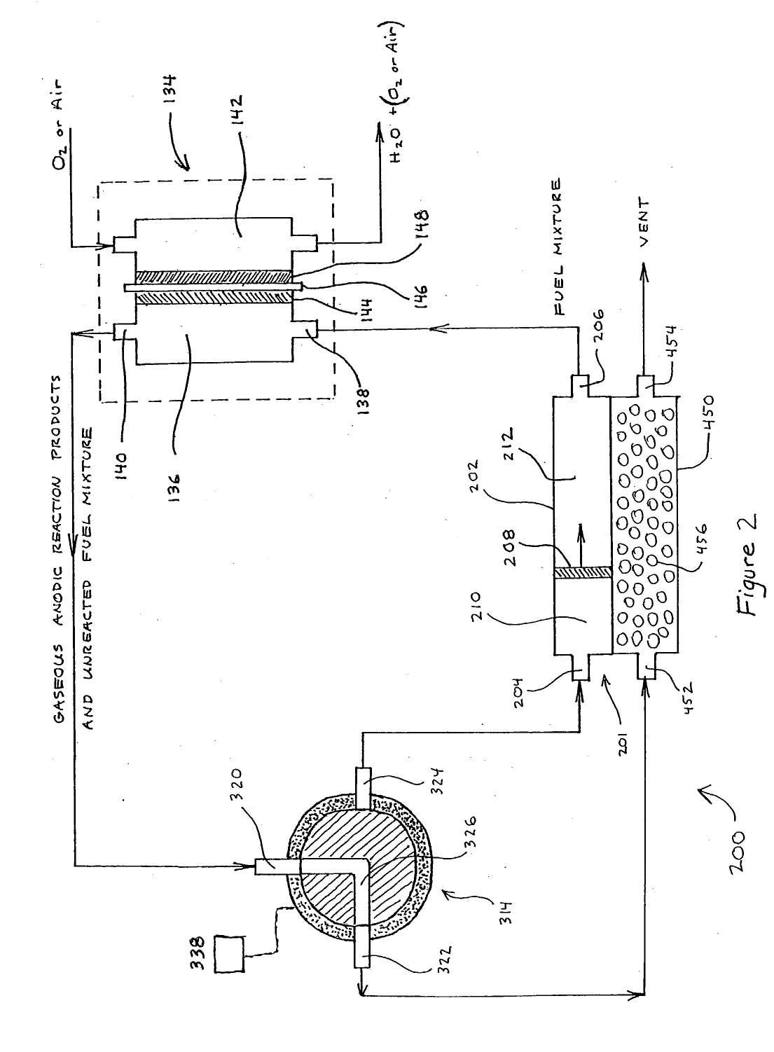

In a related, more specific embodiment of the disclosed exhaust gas-driven fluid flow device, the latter comprises a fluid flow-routing device that is an electrically actuated, 3-way fluid flow-routing valve. This embodiment is illustrated in FIG. 1 as exhaust gas-driven fuel flow device 100, adapted to deliver a liquid fuel to the anode flow field 136 of a DFFC 134. A further related embodiment is schematically illustrated in FIG. 2 as exhaust gas-driven fuel flow device 200, also adapted to deliver a liquid fuel to the anode flow field 136 of a DFFC 134. Fuel flow device 200 is the same as fuel flow device 100 except for comprising exhaust tank 450.

Referring to FIGS. 1 and 2, each of the exhaust gas-driven fuel flow devices 100 and 200, as shown, comprises an enclosure/partition assembly that is a cylinder/piston assembly 201 and an electrically actuated 3-way fluid flow-routing valve 314. The cylinder 202 comprises an inlet 204 and an outlet 206. Located inside of the cylinder 202 is a piston 208. The latter is slidably moveable therewithin. In one embodiment, the piston 208 and cylinder 202 are configured such that, during operation, the piston 208 only moves in one direction, that being away from the inlet 204 and toward the outlet 206. The piston 208 slidably engages with the cylinder 202 so as to divide the interior space thereof into a first chamber 210 and a second chamber 212.

As shown, the first chamber 210 is fluidly connected to the cylinder inlet 204, and the second chamber 212 is fluidly connected to the cylinder outlet 206. Generally, during operation, the piston 208 moves so as to increase the volume of the first chamber 210 and decrease that of the second chamber 212. This is always the case where the piston 208 is a one-way piston. It should be appreciated that the lateral cross-sectional shape of the cylinder 202 can be other than circular, and can, for example, be square, rectangular, oval, triangular, hexagonal, octagonal, as well as other shapes.

Still referring to FIGS. 1 and 2, the 3-way fluid flow-routing valve 314 comprises an inlet port 320, a first outlet port 322, a second outlet port 324, and a passageway 326. Operation of valve 314 is controlled by controller 338. As shown, the second outlet port 324 is fluidly connected to the cylinder inlet 204, and the first outlet port 322 is in fluid communication with an ambient environment, thus providing a vent. Also, the electrically actuated fluid flow-routing valve 314, operated by controller 338, is adapted to provide first and second fluid connections. As shown in FIG. 1, when the first fluid connection is provided, the inlet port 320 and second outlet port 324 are fluidly connected, while being fluidly isolated from the first outlet port 322. As shown in FIG. 2, when the second fluid connection is provided, the inlet port 320 and first outlet port 322 are fluidly connected, while being fluidly isolated from the second outlet port 324.

During operation, as shown in FIGS. 1 and 2, the exhaust gas-driven fuel flow device 100 is fluidly connected to a DFFC 134, the latter comprising an anode flow field 136, a cathode flow field 142, an anode 144, an electrolyte 146 and a cathode 148. The anode flow field 136 comprises an inlet 138 and an outlet 140. The outlet 206 of the cylinder/piston assembly 201 is fluidly connected to the inlet 138 of the anode flow field 136, and the outlet 140 thereof is fluidly connected to the inlet port 320 of the fluid flow-routing valve 314. Also, during operation, the first chamber 210 contains a quantity of exhaust gas, and the second chamber 212 contains a quantity of liquid fuel mixture.

Thus, as shown in FIG. 1, the first fluid connection is characterized by the anode flow field 136 being in fluid communication with both the first chamber 210 and second chamber 212 of the cylinder 202, while the anode flow field 136 and the first and second chambers 210 and 212 are fluidly isolated from the ambient environment. Also, as shown in FIG. 2 the second fluid connection is characterized by the anode flow field 136 being in fluid communication with the second chamber 212 and ambient environment (e.g., atmosphere), while the first chamber 210 is substantially fluidly isolated. While FIGS. 1 and 2 show the first outlet port 322 in fluid communication with an ambient environment, it may be in fluid communication with an environment that is not ambient and needs only to be in fluid communication with an environment that is at a pressure less than that in the anode flow field 136 during operation.

The fuel flow-routing valve 314, shown in FIGS. 1 and 2, has been described as being electrically actuated, with the electrical power being provided to it by the DFFC 134. However, in alternative embodiments, valve 314 may be operated manually or by an actuator driven by pressure and incorporating a piezo-switch. Further still, the valve might be actuated by a pressure-driven actuator where the pressure used is derived from the pressurized exhaust gases of the DFFC.

Also, as is appreciated by one skilled in the art, there are a number of ways in which a disclosed fluid flow-routing device may provide, in an alternating fashion, first and second fluid flow-routing pathways. For instance, other valve types and/or configurations may be employed. As a more specific example, and referring again to FIGS. 1 and 2, two simple shut-off valves may be connected to the anode flow field outlet 140, in which one valve directs the flow of exhaust gas from the anode flow field 136 of the DFFC 134 to the atmosphere, while the other valve directs the flow to the first chamber 210. Controller 338 then simply controls both valves such that one is opened while the other is closed in order to effect the desired fuel pumping.

The embodiment in FIG. 2 shows an optional exhaust tank 450 that may be employed to capture exhaust gas if desired. As shown, the exhaust tank 450 comprises an inlet 452 and an outlet 454. Here, the first outlet port 322 of the fluid flow-routing valve 314 is fluidly connected to the inlet 452 of the exhaust tank 450 and is in fluid communication with an ambient environment therethrough. Exhaust tank 450 contains a material 456 in its interior space capable of adsorbing or otherwise capturing at least some of the exhaust gas vented therethrough, particularly those components of the exhaust gas associated with unreacted fuel. Typically, the exhaust tank 450 may be integrally attached to the cylinder 202, or the exhaust tank 450 and cylinder 202 may be combined in a disposable fuel cartridge. In another specific, related embodiment, the cylinder 202 is adapted to be recharged with fuel when emptied.

In another embodiment, the present invention is directed to a liquid-fueled DFFC that comprises a disclosed fuel flow device. In a related, more specific embodiment, the liquid-fueled DFFC is a DMFC where the fuel used therefor is a mixture of methanol and water.

The above-disclosed fuel flow device may then be used, in another embodiment of the present invention, for a method of delivering a liquid fuel to the anode flow field of a DFFC. The method is accomplished by 1) providing a disclosed fuel flow device and the DFFC, fluidly connected as described above, and where the second chamber of the enclosure of the fuel flow device contains a quantity of the liquid fuel; and 2) operating the fluid flow-routing device to alternatingly effect first and second states of fluid communication. With reference to the apparatus shown in FIGS. 1 and 2, the first state is effected by providing the above-described first fluid connection between inlet port 320 and second outlet port 324. This causes equal pressures within the first and second chambers 210 and 212. The second state is effected by providing the above-described second fluid connection between inlet port 320 and first outlet port 322. This causes the pressure within the first chamber 210 to exceed that within the second chamber 212, in turn, causing the piston 208 to move and push a quantity of the liquid fuel from the second chamber 212 to the anode flow field 136.

Typically, the second chamber 212 of the cylinder 202 is initially filled with the fuel to be delivered. Also, the fluid flow-routing valve 314 is initially actuated to provide the first fluid connection, as shown in FIG. 1. A quantity of the liquid fuel flows to the anode flow field 136 to begin the anodic oxidation reaction and associated generation of exhaust gas. This initial flow may result from natural diffusion of the fuel or from the second chamber 212 being initially pressurized, as some examples.

During this initial flow, the fluid flow-routing valve 314 continues to provide the first fluid connection to allow the anode flow field 136, the first chamber 210 and the second chamber 212 to be fluidly connected, while being fluidly isolated from the ambient environment (e.g., the atmosphere) for a period of time such that the pressure in the first chamber 210 approaches or equals the pressure in the second chamber 212. The pressure is greater than ambient pressure due to the generation of the exhaust gas by the oxidation reaction at the anode 144. When there is no pressure difference across the piston 208, the latter is stationary.

Then, the fluid flow-routing valve 314 is actuated to provide the second fluid connection, as shown in FIG. 2, using controller 338. This allows the anode fuel flow field 136 and the second chamber 212 to be in fluid communication with the ambient environment, while fluidly isolating the first chamber 210 therefrom. As a result, the pressure in the anode flow field 136 and second chamber 212 decreases to ambient pressure, while the pressure in the first chamber 210 initially remains at the greater pressure realized when the first fluid connection 334 was provided. The associated pressure difference across the piston 208 causes the latter to move toward the cylinder outlet 206, pushing a portion of the fuel out therethrough and into the anode flow field 136 of the DFFC 134. As the piston 208 moves and the volume of the first chamber 210 increases, the pressure therein decreases accordingly, and the movement of the piston 208 slows or stops.

Typically, when the movement of the piston 208 slows or stops, the fluid flow-routing valve 314 is actuated to, once again, provide the first fluid connection. As before, the pressures in the two chambers 210 and 212 of the cylinder 202, and in the anode flow field 136, equalize at a pressure greater than ambient. Thus, the fluid flow-routing valve 314 is actuated to alternatingly provide the two fluid connections, as described above, to thereby continue delivering the liquid fuel to the anode flow field 136. Typically, the fuel is so delivered until either the DFFC 134 is shut down or the second chamber 212 is emptied of the fuel.

Controller 338 is used to signal the valve 314 to switch between the first and second fluid connections. Such controllers, and the operation thereof, are well known in the art. For example, with regard to the operation thereof, a desired switching frequency or progression of frequencies may be based on the fuel consumption in the DFFC 134 and based on the relative volumes of the various components in the fuel pathway. Depending on how the DFFC is used, the fuel consumption may vary significantly, however. Thus, it may be desirable to sense the current output of the DFFC 134, which is indicative of the amount of fuel consumed per unit time, and then provide this information to controller 338 in order to control the switching frequency of valve 314. Also, the frequency or progression of frequencies may be selected to deliver liquid fuel to the anode 144 of the DFFC 134 in accordance with the power output demanded thereof, while minimizing the amount of unreacted fuel vented to the environment.

For the above-disclosed embodiments shown in FIGS. 1 and 2, when the second chamber 212 of the cylinder 202 is emptied of fuel, the cylinder 202 is adapted to either be removed and replaced with another cylinder filled with fuel, or refilled with additional fuel. For example, there may be a mechanical release allowing the one-way piston to be moved back to its initial position (i.e., when the second chamber 212 of the cylinder 202 is filled with fuel), thereby allowing the second chamber 212 to be refilled with fuel.

Thus, according to the above embodiments, a liquid fuel is delivered to a DFFC using a disclosed fuel flow device that is essentially only powered by pressurized exhaust gases generated by anodic chemical reactions in the anode flow field of the DFFC. In this way, harnessing the energy associated with the pressurized exhaust gases—energy that would otherwise be wasted—obviates the need to parasitically diminish the electrical output of the DFFC to a significant extent.

Where a disclosed fuel flow device comprises a fluid flow-routing device that is actuated using electrical power, the source thereof would typically be the electrical output of the DFFC. However, the electrical power required for such actuation is minimal, and is negligible compared to the electrical power that might otherwise be required to deliver fuel to the DFFC.

It should be appreciated that the above-disclosed exhaust gas-driven fuel flow devices, in addition to being adapted to pump liquid fuel to a DFFC, may be characterized by a variety of sizes and capacities, in terms of the dimensions of the components thereof and the rate at which fuel is fed to a DFFC or stack thereof. For example, at one end of the spectrum, a disclosed device may be used to feed liquid fuel to multiple DFFC stacks of a large capacity, stationary electrical power-generating plant. Or, a disclosed device may be used to feed liquid fuel to a DFFC stack of an electrical power plant used for a fuel cell-powered motor vehicle. At the other end of the spectrum, a disclosed exhaust gas-driven fuel flow device may be miniaturized, being thereby adapted to deliver liquid fuel to a miniaturized DFFC or stack thereof (i.e., <20 W power output). The latter may be used for portable electronic devices, such as computers and cellular telephones.

In another aspect, directed to the delivery of gaseous oxidant (generally air) to the cathode of a liquid-fueled DFFC, in particular, disclosed is a DFFC stack comprising a plurality of stacked DFFCs, where each DFFC comprises a cathode flow field plate, adapted for coextensive contact with a cathode of the DFFC stack, and where at least one of the cathode flow field plates is as described below. As is well understood by the skilled artisan, the term “coextensive,” as used herein, refers to the flow field plate being positioned with respect to the cathode so that the flow field thereof is laterally aligned with the electrochemically-active area of the cathode, and the mating surfaces of the cathode and flow field are substantially parallel over the area.

The at least one of the cathode flow field plates comprises an electrically conductive and substantially fluid impenetrable base plate having first and second major surfaces. The first major surface faces a cathode and has projecting therefrom a plurality of rigid, finger-like protrusions (hereinafter, “island members”) that collectively form a landing for contact with the cathode. In a related embodiment, each island member projects from the first major planar surface to about the same height thereabove, so that substantially all of the projecting ends of the island members are in contact with the cathode brought into coextensive contact with the cathode flow field plate.

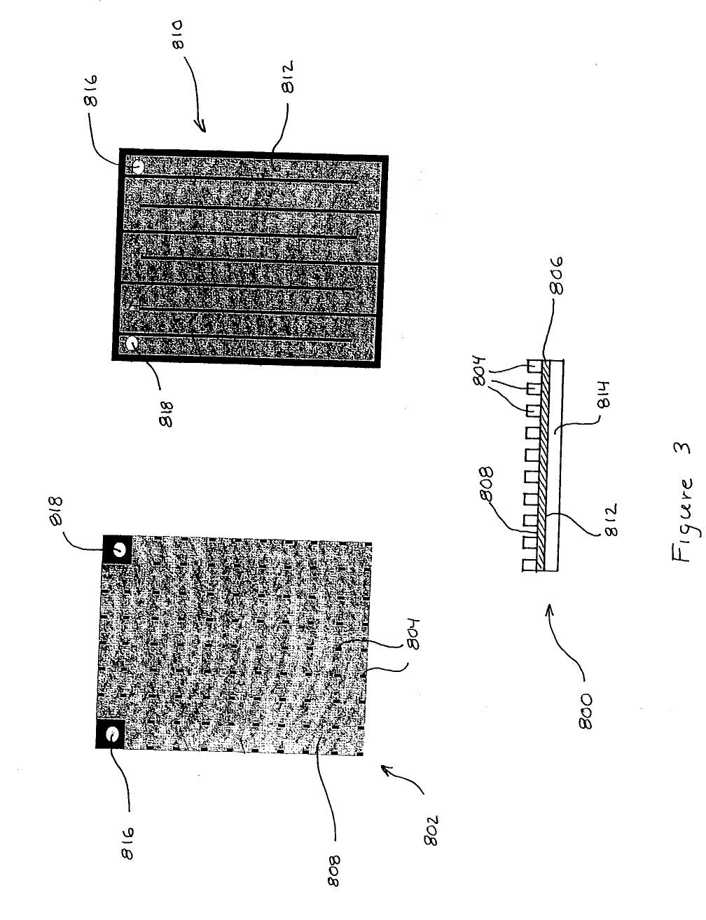

The rigid island members, together with the base plate, provide mechanical support for the cathode, as well as a plurality of electrically conductive pathways for electrons flowing thereto. In addition, as substantially all island members are spaced apart, as shown for example in FIG. 3, when the landing of the disclosed flow field plate is in intimate contact with a cathode, the contacted cathode surface, first major surface, and island members form a plurality of multi-directional passageways for the flow of oxidant therethrough. In a related embodiment, the present invention is directed to a liquid-fueled DFFC stack comprising at least one disclosed cathode flow field plate, where the DFFC stack comprises a plurality of stacked DFFCs that are miniaturized.

In a related embodiment, the present invention is directed to a DFFC stack comprising at least one bipolar plate where the latter, in turn, comprises a disclosed cathode flow field plate. The bipolar plate (i.e., bipolar flow field plate) may have fuel inlet and outlet ports, a base plate as described above, a cathode side as described above, and an anode side. An electrically conductive, rigid member projects from the second major surface of the base plate (i.e., on the anode side) so as to form, together with an anode surface and second major planar surface, at least one passageway for fuel flow when in contact with the anode of a fuel cell.

FIG. 3 illustrates one example of a miniature bipolar plate of the present invention. As shown, the bipolar plate 800 comprises a base plate 806 that is planar, having first and second major planar surfaces 808 and 812. Projecting from the first major planar surface 808 are a plurality of island members 804. As shown on cathode side 802 of bipolar plate 800, the island members 804 are arranged in rows and columns of an ordered array. Also as shown, each island member 804 has lateral cross-sectional shape that is rectangular. The cathode flow field thus consists essentially of plate 806 and rectangular island members 804.

It should be appreciated that the plurality of island members 804 may, as illustrated in FIG. 3, be arranged in more random arrays and may have different lateral cross-sectional shapes that are, square, round, oval, triangular, diamond, or a mixture thereof, as only some examples. It should also be appreciated that an array of island members can also be regarded as a grid of grooves formed into a flow field plate.

Referring again to FIG. 3, shown projecting from the second major planar surface 812 on the anode side 810 of the miniature bipolar plate 800 are members that form a continuous, serpentine channel through which a fluid fuel flows when the anode side 810 is in contact with an anode. Although serpentine, such a channel is referred to herein as mono-directional in the sense that all oxidant flowing through the associated flow field follows the same path. Fuel inlet and outlet ports 816 and 818 respectively access the serpentine fuel flow channel through plate 806. Ports 816 and 818 are however fluidly isolated from the cathode side 802.

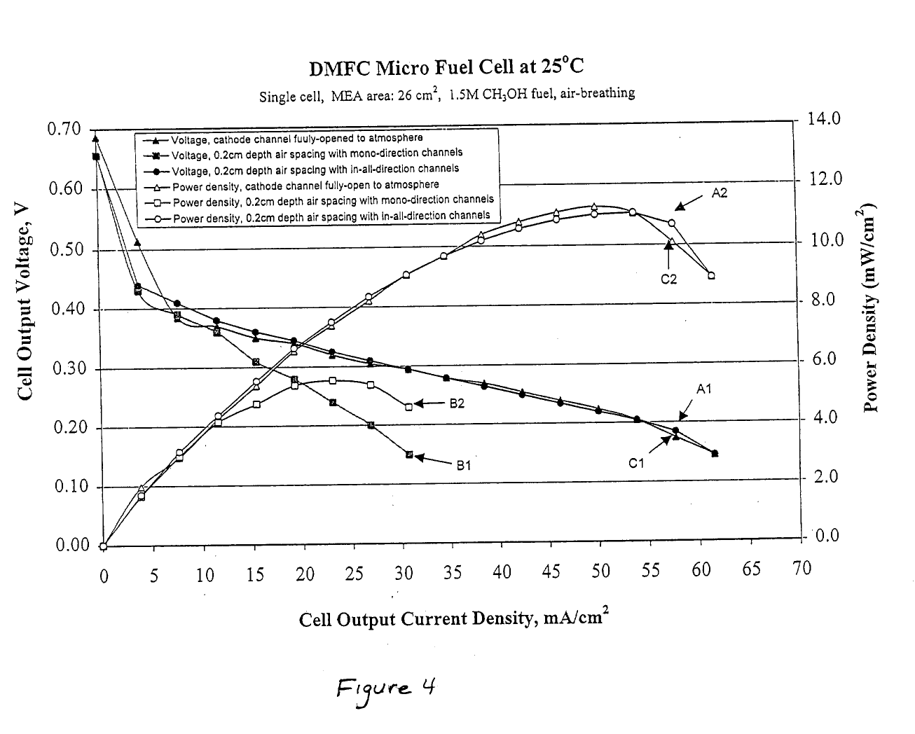

It has been unexpectedly found that, where passive oxidant delivery and product water removal is used, the voltage and power density performance of a miniature direct liquid feed fuel cell in a stack that utilizes the cathode oxidant flow field plate of the present invention is significantly better than such performance obtained when a more conventional flow field plate design (i.e., having mono-directional channels) is used; and is roughly equivalent to such performance of a miniature fuel cell having cathode channels fully exposed to the atmosphere (see Example below and FIG. 4).

The present invention is also directed to a method for enhancing the voltage and power density performance of a liquid-fueled DFFC stack having oxidant passively delivered thereto and product water passively removed therefrom. The method comprises incorporating a disclosed cathode fuel flow plate or a bipolar plate of the present invention into the DFFC stack so as to provide flow fields, structural support for anodes and cathodes, and electrically conductive pathways, as would be appreciated by one skilled in the art. In a related embodiment, the liquid-fueled DFFC stack is miniaturized.

The following example is provided for the purpose of illustration, not limitation.

### EXAMPLE

### Voltage and Power Density Performance of a Miniature Fuel Cell Stack Incorporating a Cathode Flow Field Plate of the Present Invention

The voltage and power density performance of a single miniature fuel cell, having air passively delivered thereto as the oxidant and product water passively removed therefrom, was measured for three different cathode configurations. The first configuration, A, was a cathode in contact with parallel flow channel wall members providing mono-directional flow channels, where the cathode and flow channels were fully-exposed to the atmosphere, that is, having infinite channel depth. The performance of this configuration was used as the baseline for purposes of comparison. In the second configuration, B, the parallel channel wall members were sandwiched between the cathode and a plate so as to provide channels having a channel depth for airflow (i.e., spacing between the cathode surface and plate) of 0.2 cm. In the third configuration, C, the channel wall members were cut at right angles to yield an array of rectangular island members (as depicted in FIG. 2), also sandwiched between the cathode surface and a plate so as to yield multi-directional channels having the same channel depth for airflow of 0.2 cm.

For all three configurations, the fuel used was a 1.5 M solution of methanol and de-ionized water. The active MEA area of the miniature fuel cell was 26 cm². The MEA used was of a type considered suitable for use in DMFCs. The cathode thereof was prepared using a carbon fibre non-woven with 6% PTFE, a carbon base of about 0.6 mg/cm², and a loading of Pt black catalyst of about 3.6 mg/cm². The anode thereof was prepared using a carbon fibre non-woven and a loading of Pt/Ru black catalyst of about 4.0 mg/cm². The PEM thereof was Nafion® 115.

Cell voltage and power density, as a function of cell output current density at room temperature, was measured using a test apparatus that included a load bank, multimeter and temperature meter. The results are shown in FIG. 4 in which plots A1, A2, and A3 represent the voltage of the first, second and third configurations respectively and A2, B2, and B3 represent the respective power densities. As shown, the performance obtained for the second configuration B falls substantially short of that obtained for the first configuration A, either as a result of less effective air supply to the cathode or less effective water removal from the cathode or both. On the other hand, the performance obtained for the third configuration C is roughly equivalent to that obtained for the first configuration A. This demonstrates that miniature fuel cells with cathode flow field plates utilizing arrays of island members can provide similar results to those obtained from fully open or planar type cells. Hence such flow field plates allow for stacking of miniature fuel cells with acceptably narrow spacing between adjacent anodes and cathodes, so as to provide sufficiently compact systems.

From the foregoing, it will be appreciated that, although specific embodiments of the present invention have been described herein for purposes of illustration, various modifications may be made without deviating from the spirit and scope of the invention. Accordingly, the present invention is not limited except as by the appended claims.

What is claimed is:

1. An exhaust gas-driven fuel flow device, adapted to deliver a liquid fuel to an anode flow field of a direct feed fuel cell, comprising:
an enclosure having an inlet and an outlet, the outlet for fluid connection to an inlet of the anode fuel flow field;
a substantially fluid impermeable partition, located within the enclosure and dividing the interior space thereof into substantially fluidly-isolated first and second chambers, wherein the first chamber is fluidly connected to the enclosure inlet and is adapted to contain an exhaust gas from the anode flow field, and the second chamber is fluidly connected to the enclosure outlet and is adapted to contain the liquid fuel; and the partition being capable of moving so as to cause the second chamber volume to decrease and the first chamber volume to increase; and
a fluid flow-routing device comprising an inlet port for fluid connection to an outlet of the anode flow field, a first outlet port for fluid connection to an environment at a pressure less than that in the anode flow field during operation, and a second outlet port fluidly connected to the enclosure inlet;
wherein the fluid flow-routing device is adapted to provide, in an alternating fashion, 1) a first fluid connection between the inlet port and the second outlet port while fluidly isolating the same from the first outlet port; and 2) a second fluid connection between the inlet port and first outlet port, while fluidly isolating the same from the second outlet port.

2. The exhaust gas-driven fuel flow device of claim 1 wherein the enclosure is a cylinder, and the partition is a one-way piston adapted to move in one direction only from the enclosure inlet toward the enclosure outlet.

3. The exhaust gas-driven fuel flow device of claim 1 wherein the environment is ambient at substantially atmospheric pressure.

4. The exhaust gas-driven fuel flow device of claim 1 wherein the fluid flow-routing device is a 3-way valve.

5. The exhaust gas-driven fuel flow device of claim 1 wherein the fluid flow-routing device comprises an electrically powered actuator for alternatingly providing the first and second fluid connections.

6. The exhaust gas-driven fuel flow device of claim 5 wherein power for the actuator is provided by the fuel cell.

7. The exhaust gas-driven fuel flow device of claim 1 wherein the fluid flow-routing device comprises an actuator driven by pressure and comprises a piezo-switch.

8. The exhaust gas-driven fuel flow device of claim 1 wherein the fluid flow-routing device comprises a manually driven actuator.

9. The exhaust gas-driven fuel flow device of claim 1, further comprising a controller adapted to operate the fluid flow-routing device to alternatingly provide the first and second fluid connections at selected switching frequencies and/or progressions of switching frequencies.

10. The exhaust gas-driven fuel flow device of claim 1, further comprising an exhaust tank having an inlet and an outlet, wherein the first outlet port of the fluid flow-routing device is fluidly connected to the exhaust tank inlet, and the exhaust tank outlet is in fluid communication with the environment, and wherein the exhaust tank comprises therewithin a material capable of capturing at least a portion of the exhaust gas.

11. The exhaust gas-driven fuel flow device of claim 10 wherein the exhaust tank is integrally attached to the enclosure.

12. The exhaust gas-driven fuel flow device of claim 10 wherein the exhaust tank and enclosure are combined in a disposable fuel cartridge.

13. The exhaust gas-driven fuel flow device of claim 1 wherein the enclosure is adapted to be recharged with additional fuel when emptied.

14. A liquid-fueled direct feed fuel cell comprising the exhaust gas-driven fuel flow device of claim 1.

15. The liquid-fueled direct feed fuel cell of claim 14 wherein the fuel cell is a direct methanol fuel cell and the fuel is a mixture of methanol and water.

16. A method for delivering a liquid fuel to a direct feed fuel cell, comprising the steps of:
(a) providing the fuel cell with the exhaust gas-driven fuel flow device of claim 1 having a quantity of the liquid fuel contained in the second chamber of the enclosure thereof; and
(b) operating the fluid flow-routing device to alternatingly provide 1) a first fluid connection between the inlet port and the second outlet port while fluidly isolating the same from the first outlet port to thereby establish equal pressures within the first and second chambers; and 2) a second fluid connection between the inlet port and first outlet port, while fluidly isolating the same from the second outlet port to thereby cause the pressure within the first chamber to exceed that within the second chamber, in turn, causing the partition to move and push a quantity of the liquid fuel from the second chamber to the anode flow field.

17. A liquid-fueled direct feed fuel cell stack comprising a plurality of stacked liquid-fueled direct feed fuel cells, each fuel cell comprising a cathode flow field plate wherein at least one cathode flow field plate consists essentially of a planar base plate having first and second major surfaces and a plurality of electrically conductive, rigid island members projecting from the first major surface and having projecting ends, the projecting ends collectively providing a landing for contact with a cathode.

18. The liquid-fueled direct feed fuel cell stack of claim 17 wherein the plurality of stacked liquid-fueled direct feed fuel cells are miniaturized.

19. The liquid-fueled direct feed fuel cell stack of claim 17 wherein the projecting ends of the island members in the cathode flow field plate are substantially equal in length, and wherein the island members are arranged so as to provide, when in contact with the cathode, a plurality of multi-directional passageways formed by the island members, the contacted cathode surface, and the first major surface.

20. A liquid-fueled direct feed fuel cell stack comprising at least one bipolar plate comprising the at least one cathode flow field plate of claim 17.

21. A method for enhancing the performance of a liquid-fueled direct feed fuel cell stack, having gaseous oxidant passively delivered thereto and product water passively removed therefrom, comprising the step of employing at least one cathode flow field plate consisting essentially of a planar base plate having first and second major surfaces and a plurality of electrically conductive, rigid island members projecting from the first major surface and having projecting ends, the projecting ends collectively providing a landing for contact with a cathode.

22. The method of claim 21 wherein the liquid-fueled direct feed fuel cell stack is miniaturized.
